(19) United States
(12) Patent Application Publication
(10) Pub. No.: US 2025/0077661 A1
(43) Pub. Date: Mar. 6, 2025

(54) Email Security Detection Apparatus, Method and Device, and Storage Medium

(71) Applicant: Dbappsecurity Co.,Ltd, Hangzhou (CN)

(72) Inventors: Ru FAN, Hangzhou (CN); Shilin MA, Hangzhou (CN); Yuan FAN, Hangzhou (CN)

(21) Appl. No.: 18/544,474

(22) Filed: Dec. 19, 2023

(30) Foreign Application Priority Data
Aug. 28, 2023 (CN) 202311091157.5

(51) Int. Cl. G06F 21/55

(52) U.S. Cl. CPC G06F 21/554; G06F 2221/034

(57) ABSTRACT

The present disclosure relates to the field of email security detection. Disclosed are an email security detection apparatus, method and device, and a storage medium. The method includes: an email feature extraction component, configured to collect and extract the behavior features of a sender and a recipient of an email, and the main body features of the email; a behavior feature analysis component, configured to comprehensively analyze the extracted behavior features of the sender and the receiver to identify a suspicious phishing email; a main body feature analysis component, configured to detect and analyze the extracted main body features of the email, and identify a suspicious phishing email; and an email filtering and alarming component, configured to perform filtering and real-time alarming and pushing on the suspicious phishing email identified by at least one of the behavior feature analysis component and the main body feature analysis component.

### TECHNICAL FIELD

The present disclosure relates to the field of email security detection, and in particular, to an email security detection apparatus, method and device, and a storage medium.

### BACKGROUND

With the wide application of emails, phishing emails become an increasingly serious network security threat. A phishing email refers to a fraudulent email sent by impersonating a legal entity, and is usually aimed at spoofing a trusted recipient to induce them to leak personal sensitive information, click a malicious link, or download a malicious attachment. A phishing email not only poses a threat to personal privacy and property security, but also may cause a major loss to confidential information and commercial benefits of enterprises and organizations.

Conventional phishing email detection techniques focus only on certain specific email features, such as the email subject or attachment type, while ignoring other important behavior patterns. This limits the accuracy and completeness of the detection technique and makes it difficult to identify highly simulated phishing emails.

### SUMMARY

The present disclosure is to provide an email security detection apparatus, method and device, and a storage medium.

An embodiment of the present disclosure provides an email security detection apparatus, the apparatus includes:
an email feature extraction component, configured to collect and extract behavior features of a sender and a recipient of an email, and main body features of the email;
a behavior feature analysis component, configured to comprehensively analyze the extracted behavior features of the sender and the recipient to identify a suspicious phishing email;
a main body feature analysis component, configured to detect and analyze the extracted main body features of the email, and identifying a suspicious phishing email; and
an email filtering and alarming component, configured to perform filtering and real-time alarming and pushing on the suspicious phishing email identified by at least one of the behavior feature analysis component and the main body feature analysis component.

In one or more embodiments, in the email security detection apparatus provided in the embodiments of the present disclosure, the email feature extraction component includes:
an email data acquisition unit, configured to connect to an email backup server and pull email data in a polling manner; and
an email feature extraction unit, configured to process the email data, extract the behavior features of the sender and the recipient corresponding to the email data, and the main body features of the email, and transmit the behavior features to a database by means of Kafka in real time.

In one or more embodiments, in the email security detection apparatus provided in the embodiments of the present disclosure, the behavior analyzing component includes:
an email sending frequency feature analysis unit configured to collect, from the behavior features of the sender, the number of similar email subjects sent to a plurality of recipients by the same sender within a first set time period, and if the collected number exceeds a set number threshold, then regarding the similar mails sent by the same sender within the first set time period as suspicious phishing emails;
an email sender credibility feature analysis unit configured to collect, from the behavior features of the sender, an average difference degree between domain names of different sender sending the same email subject within a second set time period, obtaining a credibility of the sender according to the obtained average difference degree, and if the credibility of the sender is lower than a set credibility threshold, regarding the emails sent by the sender within the second set time period as suspicious phishing emails; and
a statistical sender historical behavior analysis unit configured to collect a historical email record of the sender from the behavior features of the sender, and if the sender is a sender newly registered and having no historical email record or performing email interaction with a plurality of irrelevant recipients, regarding emails sent by the sender as suspicious phishing emails.

In one or more embodiments, in the email security checking apparatus provided in the embodiments of the present disclosure, the email sender credibility feature analysis unit is specifically configured to splice the domain names of different sender sending the same email subject in the second time period into a character string; count the frequency of occurrence of each character in the character string, and obtain the position of occurrence of each character in the character string; calculate the square of a difference value between the position of each character and an average position, and add same to a difference value list; and sum all the characters in the difference value list to obtain a total difference degree; and divide the total difference degree by the length of the list to obtain the average difference degree.

In one or more embodiments, in the email security detection apparatus provided in the embodiments of the present disclosure, the behavior analyzing component further includes:
a recipient behavior pattern analysis unit 24, configured to collect a behavior pattern of a recipient from the behavior features of the recipient, and analyze the behavior pattern of the recipient to identify whether an email received by the recipient is a suspicious phishing email; and
a received content association analysis unit, configured to perform association analysis on the email content of the recipient, compare the similarity degree between the subject of the current email and the subject of the previous email, and identify the subject content of the suspicious phishing email.

In one or more embodiments, in the email security detection apparatus provided in the embodiments of the present disclosure, the main feature analyzing component includes:
a Uniform Resource Locator (URL) analysis unit, configured to collect a URL from the main body features of the email, and determine whether the collected URL is a fraudulent website URL; and if so, regarding the collected email corresponding to the URL as a suspicious phishing email;
an Sender Policy Framework (SPF) record analysis unit, configured to collect an SPF record of the domain name of the sender from the main body features of the email, parsing the collected SPF record to obtain an authorization server list, and determine whether a server for detecting a sent email is located in the authorization server list of the domain name of the sender; if not, regarding the email sent by the server as a suspicious phishing email;
an attachment analysis unit, configured to detect a file extension of an attachment in an email, and if the file extension does not match a text file type, then regarding the attachment as a risky attachment; scan an executable file attachment using an antivirus engine or a malware detection tool to identify whether the executable file attachment contains a malicious code; perform sensitive content detection on the name of an attachment in the email, and if the name of the attachment relates to a sensitive vocabulary or a phishing-related content, then regarding the email as a suspicious phishing email; and detect an MD5 hash value or a file feature of the attachment, to determine whether the attachment has been identified as a malicious file;
an Simple Mail Transfer Protocol (SMTP) and Mail transfer Agent (MTA) feature analysis unit, configured to analyze an email head to obtain related information about SMTP and MTA on a sender and a link, and if the domain name of the sender does not have an Internet Content Provider (ICP) filing, an email sent by the sender is considered as a suspicious phishing email; and
a threat intelligence analysis unit, configured to perform similarity detection on the collected subject of the email and a pre-constructed phishing email keyword thesaurus to identify a suspicious phishing email.

In one or more embodiments, in the email security detection apparatus provided in the embodiments of the present disclosure, the email filtering and alarming component includes:
an email filtering unit, configured to perform screening processing on the suspicious phishing emails identified by at least one of the behavior feature analysis component and the main body feature analysis component according to a set policy, and screen suspicious phishing emails that can be regarded as real phishing emails;
a threat detection unit, configured to collect the security risk degree of the screened real phishing email; and
an alarming unit, configured to alarming and pushing the screened real phishing emails and the security risk degrees thereof to a relevant person in real time.

The embodiments of the present disclosure further provide an email security detection method, including:
an email feature extraction component is used to collect and extract behavior features of a sender and a recipient of an email main body features of the email;
a behavior feature analysis component is used to comprehensively analyze the extracted behavior features of the sender and the recipient to identify a suspicious phishing email;
a main body feature analysis component is used to detect and analyze the extracted main body features of the email identifying a suspicious phishing email; and
an email filtering and alarming component is used to perform filtering and real-time alarming and pushing on the suspicious phishing email identified by at least one of the behavior feature analysis component and the main body feature analysis component.

The embodiments of the present disclosure also provide an email security detection device, including a processor and a memory, wherein the processor implements the email security detection method provided in the embodiments of the present disclosure when executing a computer program stored in the memory.

The embodiments of the present disclosure further provide a computer-readable storage medium for storing a computer program, wherein the computer program, when executed by a processor, implements the email security detection method provided in the embodiments of the present disclosure.

### BRIEF DESCRIPTION OF THE DRAWINGS

To describe the technical solutions in the embodiments of this application or in the related technology more clearly, the following briefly describes the accompanying drawings required for describing the embodiments or the related technology. Apparently, the accompanying drawings in the following description show merely some embodiments of this application, and a person of ordinary skill in the art may still derive other embodiments from the provided accompanying drawings without creative efforts.

FIG. 1 is a schematic structural diagram of an email security detection apparatus provided in an embodiment of the present disclosure;

FIG. 2 is a schematic structural diagram of an email feature extraction component provided in an embodiment of the present disclosure;

FIG. 3 is a flowchart of extracting features by an email feature extraction component provided in an embodiment of the present disclosure;

FIG. 4 is a schematic structural diagram of a behavior feature analysis component provided in an embodiment of the present disclosure;

FIG. 5 is a flowchart of a behavior feature analysis component provided in an embodiment of the present disclosure;

FIG. 6 is a schematic structural diagram of a main feature analysis component provided in an embodiment of the present disclosure;

FIG. 7 is a schematic structural diagram of an email filtering and alarming component provided in an embodiment of the present disclosure; and

FIG. 8 is a flowchart of an email security detection method provided in an embodiment of the present disclosure.

### DETAILED DESCRIPTION OF THE EMBODIMENTS

Hereinafter, the technical solutions in the embodiments of the present disclosure will be described clearly and completely with reference to the accompanying drawings of the embodiments of the present disclosure. Obviously, the embodiments as described are only some of the embodiments of the present disclosure, and are not all of the embodiments. All other embodiments obtained by a person of ordinary skill in the art based on the embodiments of the present disclosure without any inventive effort shall all fall within the scope of protection of the present disclosure.

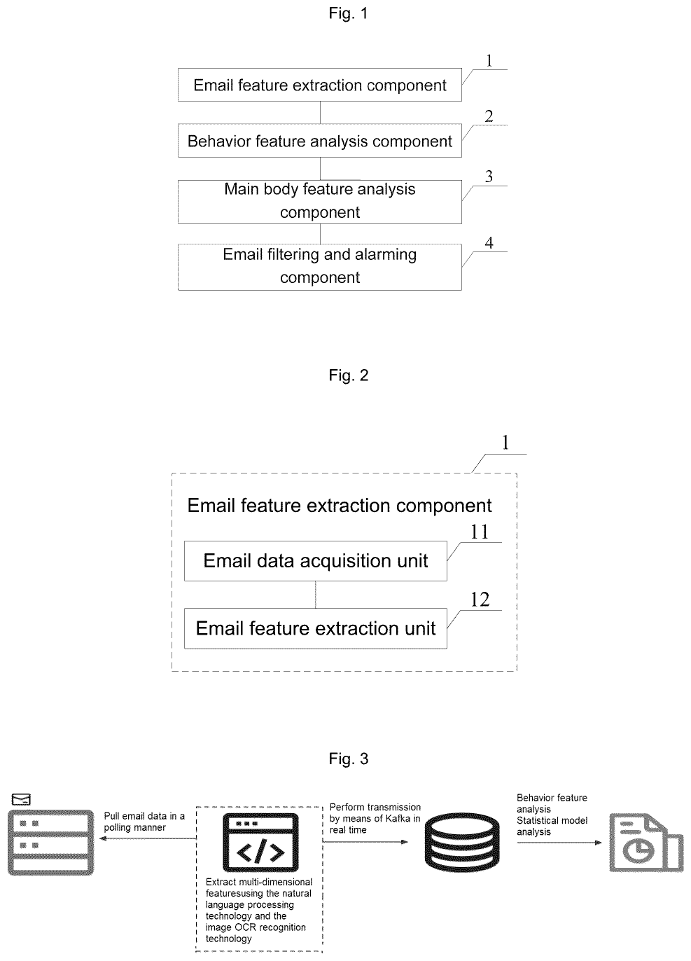

The present disclosure provides an email security detection apparatus, as shown in FIG. 1, including:
an email feature extraction component 1, configured to collect and extract behavior features of a sender and a recipient of an email, and main body features of the email;
a behavior feature analysis component 2, configured to comprehensively analyze the extracted behavior features of the sender and the recipient to identify a suspicious phishing email;
a main body feature analysis component 3, configured to detect and analyze the extracted main body features of the email, and identifying a suspicious phishing email; and
an email filtering and alarming component 4, configured to perform filtering and real-time alarming and pushing on the suspicious phishing email identified by at least one of the behavior feature analysis component and the main body feature analysis component.

The email security detection apparatus provided in the embodiment of the present disclosure comprehensively analyzes the behavior features of a sender and a recipient of an email and the main body features of the email by means of the interaction of the described four components, which can comprehensively and accurately detect the authenticity and credibility of an email, and effectively and timely recognize a suspicious phishing email, thereby improving the accuracy and efficiency of phishing email detection, and performing warning and pushing in time, so as to provide effective email security protection for a user, and solve the threat caused by phishing email to network security and information privacy of the user.

Further, in specific implementation, in the email security detection apparatus provided in an embodiment of the present disclosure, as shown in FIG. 2, the email feature extraction component 1 may include:
an email data acquisition unit 11, configured to connect to an email backup server and pull email data in a polling manner; and
an email feature extraction unit 12, configured to process the email data, extract the behavior features of the sender and the recipient corresponding to the email data, and the main body features of the email, and transmit the behavior features to a database by means of Kafka in real time.

It should be noted that, the behavior features of the sender and the recipient may include historical behavior interactions of the sender and the recipient, an email sending frequency feature, a sender credibility, the domain name of a sender, the domain name of a recipient, a recipient behavior pattern, etc.; the main body features of the email may include an email subject, an email type, links and attachments in the content of the email, an Uniform Resource Locator (URL) in the email, an Sender Policy Framework (SPF) record, email sending time, email receiving time, the sender, Simple Mail Transfer Protocol (SMTP) and Mail transfer Agent (MTA) information on the link, etc.

The email feature extraction component can be executed by an email collector agent, see the second part of FIG. 3. The agent can pull email data of the email backup server in a polling manner by connecting to the email backup server, as shown in the first part of FIG. 3, so as to collect and extract the behavior features of the sender and the recipient of the email, and multi-dimensional features such as the main body features of the email. The collected email information is transmitted to the ClickHouse database by means of Kafka in real time, as shown in the third part of FIG. 3, and is stored and analyzed. The fourth part of FIG. 3 is to perform behavior feature analysis and statistical model analysis according to a ClickHouse database of FIG. 3, so as to perform analysis and detection of an email algorithm.

To achieve efficient and accurate feature extraction, the described email feature extraction component can use a variety of methods, such as a natural language processing technology and an image analysis technology. The natural language processing technology is used for processing an email subject and content, and by means of technologies such as text analysis and semantic parsing, various parts of text content of an email are extracted therefrom. The image analysis technology is used for processing attachments in the email, including image files or other visual content. By means of technologies such as OCR recognition and image feature extraction, relevant features of an attachment, such as a two-dimensional code and picture information, can be collected, thereby further enriching the feature set of an email.

As shown in FIG. 3, the whole feature extraction process is automatically completed by an email collector agent, and through real-time connection and data transmission with a Kafka server, high-efficiency extraction and processing of a large amount of email data are achieved. The extracted feature information is stored in the ClickHouse database, providing a rich data basis for subsequent phishing email detection and analysis.

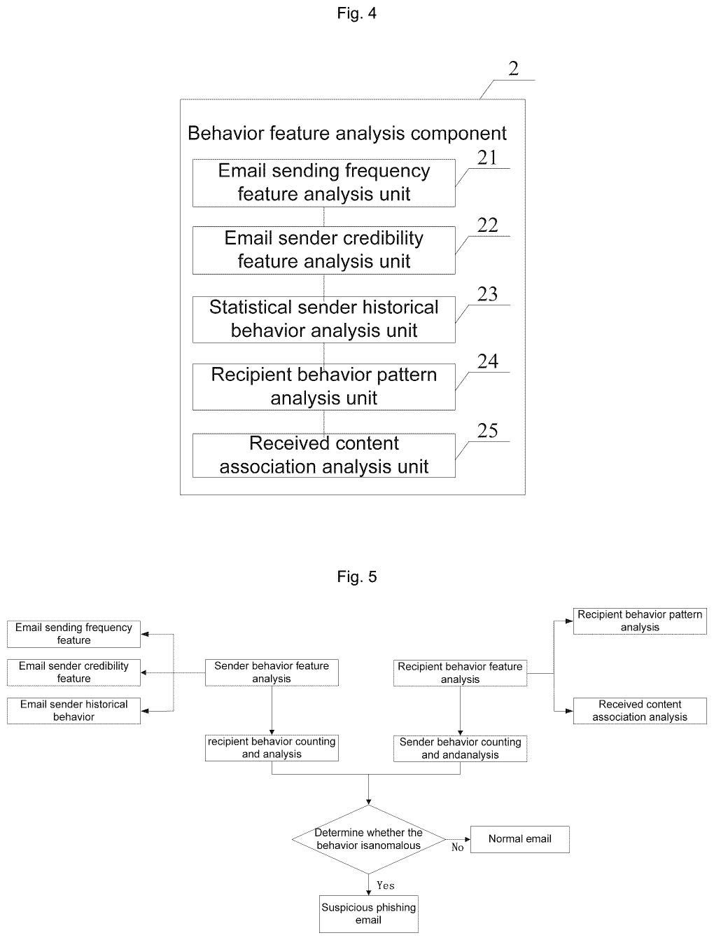

Further, in specific implementation, in the email security detection apparatus provided in an embodiment of the present disclosure, as shown in FIG. 4, the behavior feature analysis component 2 may include:
an email sending frequency feature analysis unit 21, configured to collect, from the behavior features of the sender, the number of similar email subjects sent to a plurality of recipients by the same sender within a first set time period, and if the collected number exceeds a set number threshold, then regarding the similar mails sent by the same sender within the first set time period as suspicious phishing emails,
wherein in practical applications, the email sending frequency feature analysis unit 21 may obtain the number of similar email subjects sent by the same sender to a plurality of recipients within a first set time period, and the first set time period may be one minute, one hour, or others. Generally, there may be a high probability of group sending of a phishing email, and therefore, it is an effective feature to analyze and count the frequency of sending a phishing email with a similar theme by a sender;
an email sender credibility feature analysis unit 22, configured to collect, from the behavior features of the sender, an average difference degree between domain names of different senders sending the same email subject within a second set time period, obtaining a credibility of the sender according to the obtained average difference degree, and if the credibility of the sender is lower than a set credibility threshold, regarding the emails sent by the sender within the second set time period as suspicious phishing emails,
wherein in specific implementation, the email sender credibility feature analysis unit is specifically configured to splice the domain names of different sender sending the same email subject in the second time period into a character string; count the frequency of occurrence of each character in the character string to obtain a dictionary of frequencies of characters; obtain the position of occurrence of each character in the character string, and convert same into a floating point number, representing the relative position of the element in the character string; calculate the square of a difference value between the position of each character and an average position, and add same to a difference value list; and sum all the characters in the difference value list to obtain a total difference degree; and divide the total difference degree by the length of the list to obtain the average difference degree,
wherein according to the described method, by counting the difference between domain names of the sender of the same email, a relationship network between a sender and other email users can be accurately analyzed, including a contact frequency, a contact type, etc., so as to evaluate the degree of association and the degree of reliability of the sender, the greater the degree of difference between different sender domain names of the same subject in a short time, the lower the degree of reliability of a sent email;
a statistical sender historical behavior analysis unit 23, configured to collect a historical email record of the sender from the behavior features of the sender, such as calculating a historical email subject feature of each sender and an interactive frequency between the each sender and recipient; and if the sender is a sender newly registered and having no historical email record or performing email interaction with a plurality of irrelevant recipients, regarding emails sent by the sender as suspicious phishing emails.

That is to say, if the sender is a sender newly registered and having no historical email record or performing email interaction with a plurality of irrelevant recipients, there is a higher possibility that a phishing email may exist.

The described means of the present disclosure is to construct a domain name credibility model and a historical behavior record on the basis of statistical behavior features of a time period, specifically referring to features such as the interactive frequency between the each sender and the recipient of the same or similar subject and the domain name features, so as to determine whether an email is a suspicious phishing email.

Further, in specific implementation, in the email security detection apparatus provided in an embodiment of the present disclosure, as shown in FIG. 4, the behavior feature analysis component 2 may include:
a recipient behavior pattern analysis unit 24, configured to collect a behavior pattern of a recipient from the behavior features of the recipient, and analyze the behavior pattern of the recipient to identify whether an email received by the recipient is a suspicious phishing email, for example, if the recipient has never interacted with a sender but has received the email from the sender, there may be the possibility of phishing emails;
a received content association analysis unit 25, configured to perform association analysis on the email content of the recipient, compare the similarity degree between the subject matter of the current email and the subject matter of the previous email, and identify the subject matter content of the suspicious phishing email,
wherein by comprehensively analyzing the described features, a system can more accurately determine the authenticity and the credibility of an email, and alarm a phishing email in time, thereby improving the accuracy rate and efficiency of detecting phishing emails of the system, the behavior feature analysis component 2 performs statistical aggregation analysis on the behaviors of the sender and the recipient on the basis of a statistical model and an anomaly detection algorithm, and establishes a statistical feature model of the sender and the recipient, and an anomalous behavior pattern is identified by monitoring a deviation between a behavior pattern and a normal behavior, and suspicious phishing emails are filtered out. The specific implementation flowchart is shown in FIG. 5.

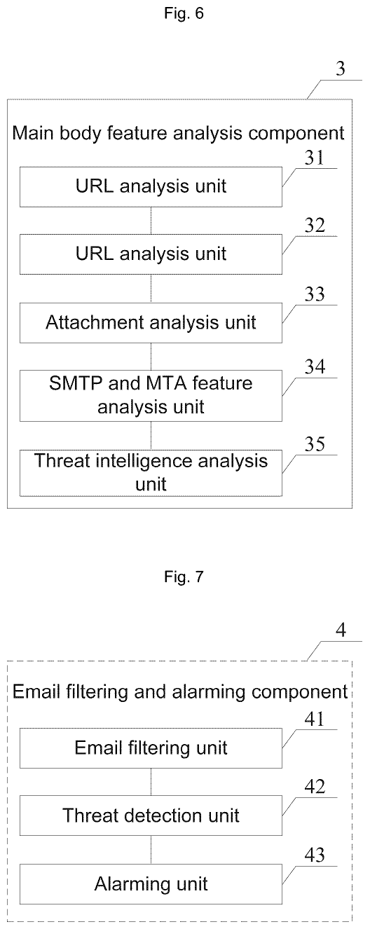

Further, in specific implementation, in the email security detection apparatus provided in an embodiment of the present disclosure, as shown in FIG. 6, the main body feature analysis component 3 may include:
a URL analysis unit 31, configured to collect a URL from the main body features of the email, and determine whether the collected URL is a fraudulent website URL; and if so, regarding the collected email corresponding to the URL as a suspicious phishing email,
wherein it should be noted that, the URL analysis unit 31 analyzes whether the URL extracted from the email is a fraudulent website URL, and a phishing website generally requires to input a user name of an email box; therefore, the email account parameter must exist in the URL sent in the email, all the URLs containing the email box account are counted and screened, and then it is further determined whether it is a phishing website by invoking a Google Safe Browsing Lookup API interface;
an SPF record analysis unit 32, configured to collect an SPF record of the domain name of the sender from the main body features of the email, parsing the collected SPF record to obtain an authorization server list, and determine whether a server for detecting a sent email is located in the authorization server list of the domain name of the sender; if not, regarding the email sent by the server as a suspicious phishing email;
wherein it should be noted that the SPF record analysis unit 32 may check whether the server sending the email is in the authorization server list of the domain names of the sender according to the SPF record in the email, if the server is not in the authorization list, the server receiving the email may regard the email as a suspicious phishing email, the specific steps include: acquiring a domain name of a sender: acquiring the domain name of the sender from an email header of an e-mail message; querying an SPF record of a sender domain name: using a domain name system (DNS) to query and collect the SPF record of the sender domain name; parsing an SPF record: parsing the SPF record to acquire an authorization server list; checking a source server of an email; acquiring an IP address of the source server of the email; checking whether the IP address of the source server is in the authorization server list: comparing the IP address of the email source server with the IP address in the authorization server list; if the IP address of the source server is in the authorization server list, regarding that the email is authorized; if the IP address of the source server is not in the authorization server list, regarding that the email may be a phishing email or a counterfeit mail;
an attachment analysis unit 33, configured to detect a file extension of an attachment in an email, and if the file extension does not match a text file type, then regarding the attachment as a risky attachment; scan an executable file attachment by using an antivirus engine or a malware detection tool to identify whether the executable file attachment contains a malicious code; perform sensitive content detection on the name of an attachment in the mail, and if the name of the attachment relates to a sensitive vocabulary or a phishing-related content, then regarding the email as a suspicious phishing email; and detect an MD5 hash value or a file feature of the attachment, to determine whether the attachment has been identified as a malicious file,
wherein it should be noted that, the phishing email usually uses a very common file type as an attachment, such as an executable file (.exe) and a compressed file (.zip), during attachment detection, the attachment analysis unit 33 may check the file extension of the attachment, and if the extension does not match a common text file type, there may be a risk; for common text file types, the attachment analysis unit 33 can verify the true format of the file by checking the file header or magic number, if the attachment is declared as a text file type, but the actual format does not match, there may be a sign of a phishing email, in addition, the attachment analysis unit 33 also detects an executable file attachment, and may use an antivirus engine or a malware detection tool to scan the executable file attachment to identify whether malicious code is contained therein,
in addition, the phishing email usually uses a fraudulent attachment name, for example, the name of common services such as banks and social media, during attachment detection, the attachment analysis unit 33 may perform sensitive content detection on the attachment name, and if it is found that the attachment name relates to a sensitive word or content related to phishing, it may be marked as a potential phishing email, in addition, the attachment analysis unit 33 may check the MD5 hash value or file features of the attachment to determine whether the attachment has been identified as a malicious file, this way can quickly identify potential phishing email attachments using existing security knowledge bases;
an SMTP MTA feature analysis unit 34, configured to analyze an email head to obtain related information about an SMTP MTA on a sender and a link, and if the domain name of the sender does not have an Internet Content Provider (ICP) filing, an email sent by the sender is considered as a suspicious phishing email,
wherein in the present disclosure, by parsing a “Received” email head in an email head, an IP address of a sender and IP and Host information of a used sender MTA can be obtained, so that more relevant information (e.g. a geographical position, an ICP, etc.) about the sender and an SMTP and MTA on a link can be obtained; in addition, according to the feature of emails of three email manufacturers (163, qq, 263) receiving an MTA service, relevant information about the sender MTA can be reversely confirmed, normal emails sent to enterprise mailboxes are generally working communication or service information, and if the sender MTA is in a domestic state, it indicates that it is a domestic service; in addition, if the sender is overseas, the domain name needs to have an ICP filing, and in this case, if the domain name of the sender does not have an ICP filing, there is a high possibility that it is a phishing email sent by a fake sender;
a threat intelligence analysis unit 35, configured to perform similarity detection on the collected subject of the email and a pre-constructed phishing email keyword thesaurus to identify a suspicious phishing email,
wherein it needs to be pointed out that the present disclosure can construct a phishing email keyword thesaurus after analyzing a large number of spam mails and phishing emails, such as important notifications, email security upgrades, financial subsidies and wage subsidies, and the threat intelligence analysis unit 35 identifies a suspicious phishing email by performing similarity detection on the collected email subjects and the keywords in the phishing email keyword thesaurus,
associating the suspicious phishing emails obtained by means of statistical behavior analysis to the anomalous features of the email main body can accurately determine a phishing email fraudulent event.

Further, in specific implementation, in the email security detection apparatus provided in an embodiment of the present disclosure, as shown in FIG. 7, the email filtering and alarming component 4 may include:
an email filtering unit 41, configured to perform screening processing on the suspicious phishing emails identified by at least one of the behavior feature analysis component and the main body feature analysis component according to a set policy, and screen suspicious phishing emails that can be regarded as real phishing emails; and
a threat detection unit 42, configured to collect the security risk degree of the screened real phishing email, wherein the threat detection unit 42 can perform threat evaluation on the screened real phishing email, and determine the degree of security risk which may be brought about thereby according to whether the email comes from an inbox or a junk box, the time when the email is sent, and the number of different recipients receiving the phishing email, etc. on the basis of an evaluation result, different levels of processing can be performed on the emails; if the receiving email boxes are all junk boxes, ignoring same, and related phishing information, including a sending IP, a sending subject, a phishing website URL, a phishing attachment, etc. is automatically stored in the base as a threat intelligence for detecting a phishing email, wherein, if the receiving email boxes are all junk boxes, ignoring same means that, if the receiving email boxes are all junk boxes, no alarm is given for the phishing emails in the junk boxes;
an alarming unit 43, configured to alarming and pushing the filtered real phishing emails and the security risk degrees thereof to a relevant person in real time. Specifically, the alarm information may be sent to an administrator or a specified person in an instant notification manner (for example, alarming by means of an email, a short message or a DingTalk group). The information generally includes evidence collection information about a phishing email, which consists of important features such as a sender, a recipient, an email subject, a sending time, a phishing website URL, important content of a phishing, and an email inbox type.

It should be noted that, the email filtering and alarming component 4 alarms and pushes the identified phishing emails to the customer, so that the customer can perform further decision making and treatment. Furthermore, the email filtering and alarming component 4 may display the alarm information of the potential phishing emails on the management console for the administrator to view and process. The administrator may perform further operations by means of the console, such as ascertaining whether an alarm is given by mistake, whether an email is blocked or removed, etc. In addition, the email filtering and alarming component 4 can record alarm information of a phishing email into a log file, so as to facilitate subsequent security analysis and tracking, the logs including the time of alarm triggering, email features, processing results, etc., which facilitates system improvement and alarm event tracing. By means of the application of the email filtering and alarming component 4, the email security detection apparatus can effectively detect a phishing email, and further generate a corresponding alarm and a log record, so that a customer can perform further tracing, and the security of an email account is protected.

It can be understood that, conventional detection methods based on rule matching and feature matching are susceptible to changes in phishing emails and hidden attacks, and the accuracy rate is limited; in the present disclosure, the behavior features of the sender and the recipient can be comprehensively analyzed, and by considering a plurality of behavior features of the sender and the recipient, such as the sending frequency of the sender, the credibility of the sender and the historical behavior, comprehensive analysis and detection of phishing emails can be achieved; an email attachment, including a file type, file content, sensitive content, etc. is detected and analyzed to identify an attachment which may contain a malicious code or a phishing link. By means of the application of an association model of statistical behavior analysis and feature analysis, the limitation of conventional phishing email detection methods is effectively solved, the accuracy of phishing email detection is improved, and the network security and information privacy protection of the user are enhanced. The conventional phishing email detection methods may require a lot of manual intervention and rule updating, which consumes time and resources. However, the email security detection apparatus of the present disclosure can quickly and efficiently process a large amount of email data by means of automatic feature extraction, analysis and model establishment, thereby improving the efficiency and processing capability of phishing email detection.

Based on the same inventive concept, the embodiments of the present disclosure further provide an email security detection method. Since the principle of the method for solving problems is similar to that of the foregoing email security detection apparatus, reference can be made to the implementation of the email security detection apparatus for implementation of the method, and details are not repeatedly described herein.

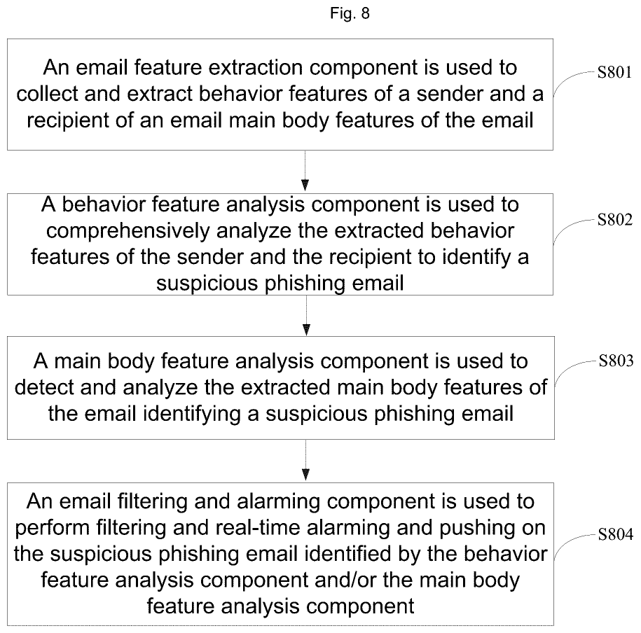

In specific implementation, as shown in FIG. 8, the email security detection method provided in the embodiment of the present disclosure specifically includes the following steps:
S801, an email feature extraction component is used to collect and extract behavior features of a sender and a recipient of an email main body features of the email;
S802, a behavior feature analysis component is used to comprehensively analyze the extracted behavior features of the sender and the recipient to identify a suspicious phishing email;
S803, a main body feature analysis component is used to detect and analyze the extracted main body features of the email identifying a suspicious phishing email; and
S804, an email filtering and alarming component is used to perform filtering and real-time alarming and pushing on the suspicious phishing email identified by at least one of the behavior feature analysis component and the main body feature analysis component.

The email security detection method provided in the embodiment of the present disclosure comprehensively analyzes the behavior features of a sender and a recipient of an email and the main body features of the email, which can comprehensively and accurately detect the authenticity and credibility of an email, and effectively and timely recognize a suspicious phishing email, thereby improving the accuracy and efficiency of phishing email detection, and performing warning and pushing in time, so as to provide effective email security protection for a user, and solve the threat caused by phishing email to network security and information privacy of the user.

For a more specific working process of the foregoing steps, reference may be made to corresponding content disclosed in the foregoing embodiments, and the details will not be repeated herein again.

Accordingly, also disclosed is an email security detection device, including a processor and a memory, wherein the email security detection method disclosed in the foregoing embodiments is implemented when a processor executes a computer program stored in the memory. For a more specific process of the foregoing method, reference may be made to corresponding content disclosed in the foregoing embodiments, and the details will not be repeated herein again.

Further, the present disclosure also discloses a computer readable storage medium for storing a computer program; the computer program implements the described email security detection method when being executed by a processor. For a more specific process of the foregoing method, reference may be made to corresponding content disclosed in the foregoing embodiments, and the details will not be repeated herein again.

The embodiments in this description are described in a progressive manner. Each embodiment focuses on differences from other embodiments. For the same or similar parts among the embodiments, reference may be made to each other. For the method, device and storage medium disclosed in the embodiment, as the apparatus corresponds to the method disclosed in the embodiment, the illustration thereof is relatively simple, and for the relevant parts, reference can be made to the illustration of the method part.

A person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraints of the technical solutions. A person skilled in the art may use different methods to implement the described functions for each particular application, but it should not be considered that the implementation goes beyond the scope of this application.

In combination with embodiments disclosed in this specification, method or algorithm steps may be implemented by hardware, a software component executed by a processor, or a combination thereof. The software component may be provided in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

Finally, it should be noted that in this description, relational terms such as first and second are only used to distinguish one entity or operation from another entity or operation, and do not require or imply any actual relationship or sequence between these entities or operations. Furthermore, terms such as “including”, “including” or any other variants are intended to cover the non-exclusive including, thereby making that the process, method, merchandise, or device including a series of elements include not only those elements but also other elements that are not listed explicitly or the inherent elements to the process, method, merchandise, or device. Without further limitation, an element defined by a sentence “including a . . . ” does not exclude other same elements existing in a process, a method, a commodity, or a device that includes the element.

The email security detection apparatus, method and device and the storage medium provided in the present disclosure are introduced in details. In this description, specific embodiments are used for illustration of the principles and implementations of the present disclosure. The description of the foregoing embodiments is used to help illustrate the method of the present disclosure and the core ideas thereof. In addition, persons of ordinary skill in the art can make various modifications in terms of specific implementations and the scope of application in accordance with the ideas of the present disclosure. In conclusion, the content of the description shall not be construed as a limitation to the present disclosure.

What is claimed is:

1. An email security detection apparatus, comprising:
an email feature extraction component, configured to collect and extract behavior features of a sender and a recipient of an email, and main body features of the email;
a behavior feature analysis component, configured to comprehensively analyze the extracted behavior features of the sender and the recipient to identify a suspicious phishing email;
a main body feature analysis component, configured to detect and analyze the extracted main body features of the email, and identifying a suspicious phishing email; and
an email filtering and alarming component, configured to perform filtering and real-time alarming and pushing on the suspicious phishing email identified by at least one of the behavior feature analysis component and the main body feature analysis component.

2. The email security detection apparatus according to claim 1, wherein the email feature extraction component comprises:
an email data acquisition unit, configured to connect to an email backup server and pull email data in a polling manner; and
an email feature extraction unit, configured to process the email data, extract the behavior features of the sender and the recipient corresponding to the email data, and the main body features of the email, and transmit the behavior features to a database by means of Kafka in real time.

3. The email security detection apparatus according to claim 1, wherein the behavior feature analysis component comprises:
an email sending frequency feature analysis unit configured to collect, from the behavior features of the sender, the number of similar email subjects sent to a plurality of recipients by the same sender within a first set time period, and if the collected number exceeds a set number threshold, then regarding the similar mails sent by the same sender within the first set time period as suspicious phishing emails;
an email sender credibility feature analysis unit configured to collect, from the behavior features of the sender, an average difference degree between different sender domain names of the same email subject within a second set time period, obtaining a credibility of the sender according to the obtained average difference degree, and if the credibility of the sender is lower than a set credibility threshold, regarding the emails sent by the sender within the second set time period as suspicious phishing emails; and
a statistical sender historical behavior analysis unit configured to collect a historical email record of the sender from the behavior features of the sender, and if the sender is a sender newly registered and having no historical email record or performing email interaction with a plurality of irrelevant recipients, regarding emails sent by the sender as suspicious phishing emails.

4. The email security detection apparatus according to claim 3, wherein the email sender credibility feature analysis unit is specifically configured to splice the domain names of different sender sending the same email subject in the second time period into a character string; count the frequency of occurrence of each character in the character string, and obtain the position of occurrence of each character in the character string; calculate the square of a difference value between the position of each character and an average position, and add same to a difference value list; and sum all the characters in the difference value list to obtain a total difference degree; and divide the total difference degree by the length of the list to obtain the average difference degree.

5. The email security detection apparatus according to claim 3, wherein the behavior feature analysis component further comprises:
a recipient behavior pattern analysis unit, configured to collect a behavior pattern of a recipient from the behavior features of the recipient, and analyze the behavior pattern of the recipient to identify whether an email received by the recipient is a suspicious phishing email; and
a received content association analysis unit, configured to perform association analysis on the email content of the recipient, compare the similarity degree between the subject of the current email and the subject of the previous email, and identify the subject content of the suspicious phishing email.

6. The email security detection apparatus according to claim 1, wherein the main body feature analysis component comprises:
a Uniform Resource Locator (URL) analysis unit, configured to collect a URL from the main body features of the email, and determine whether the collected URL is a fraudulent website URL; and if so, regarding the collected email corresponding to the URL as a suspicious phishing email;
an Sender Policy Framework (SPF) record analysis unit, configured to collect an SPF record of the domain name of the sender from the main body features of the email, parsing the collected SPF record to obtain an authorization server list, and determine whether a server for detecting a sent email is located in the authorization server list of the domain name of the sender; if not, regarding the email sent by the server as a suspicious phishing email;
an attachment analysis unit, configured to detect a file extension of an attachment in an email, and if the file extension does not match a text file type, then regarding the attachment as a risky attachment; scan an executable file attachment using an antivirus engine or a malware detection tool to identify whether the executable file attachment contains a malicious code; perform sensitive content detection on the name of an attachment in the email, and if the name of the attachment relates to a sensitive vocabulary or a phishing-related content, then regarding the email as a suspicious phishing email; and detect an MD5 hash value or a file feature of the attachment, to determine whether the attachment has been identified as a malicious file;
an Simple Mail Transfer Protocol (SMTP) and Mail transfer Agent (MTA) feature analysis unit, configured to analyze an email head to obtain related information about an SMTP and MTA on a sender and a link, and if the domain name of the sender does not have an Internet Content Provider (ICP) filing, an email sent by the sender is considered as a suspicious phishing email; and
a threat intelligence analysis unit, configured to perform similarity detection on the collected subject of the email and a pre-constructed phishing email keyword thesaurus to identify a suspicious phishing email.

7. The email security detection apparatus according to claim 1, wherein the email filtering and alarming component comprises:
an email filtering unit, configured to perform screening processing on the suspicious phishing emails identified by at least one of the behavior feature analysis component and the main body feature analysis component according to a set policy, and screen suspicious phishing emails that can be regarded as real phishing emails;
a threat detection unit, configured to collect the security risk degree of the screened real phishing email; and
an alarming unit, configured to alarming and pushing the screened real phishing emails and the security risk degrees thereof to a relevant person in real time.

8. An email security detection method, comprising:
using an email feature extraction component to collect and extract behavior features of a sender and a recipient of an email main body features of the email;
using a behavior feature analysis component to comprehensively analyze the extracted behavior features of the sender and the recipient to identify a suspicious phishing email;
using a main body feature analysis component to detect and analyze the extracted main body features of the email identifying a suspicious phishing email; and
using an email filtering and alarming component to perform filtering and real-time alarming and pushing on the suspicious phishing email identified by at least one of the behavior feature analysis component and the main body feature analysis component.

9. An email security detection device, comprising a processor and a memory, wherein the processor implements the email security detection method according to claim 8 when executing a computer program stored in the memory.
